(19) United States
(12) Patent Application Publication
(10) Pub. No.: US 2019/0135109 A1
(43) Pub. Date: May 9, 2019

(54) In-vehicle GPS Geo-Fencing Route Planning, GPS Proximity Based Advertising, Infotainment System Advertising and Infotainment System Image, Picture, Video or Hologram Emergency Alert Display

(71) Applicants: Douglas Charles Miller, JR., Franklin, MI (US); Jeffrey Floyd Miller, Mason, OH (US)

(72) Inventors: Douglas Charles Miller, JR., Franklin, MI (US); Jeffrey Floyd Miller, Mason, OH (US)

(21) Appl. No.: 15/849,983

(22) Filed: Dec. 21, 2017

Related U.S. Application Data
(60) Provisional application No. 62/582,850, filed on Nov. 7, 2017.

(51) Int. Cl. B60K 35/00; H04W 4/021; G06F 3/0488; G01C 21/36; B60Q 9/00; G07C 5/00; G06Q 30/02

(52) U.S. Cl. CPC B60K 35/00; H04W 4/021; G06F 3/0488; G01C 21/3676; H04L 2012/40273; G01C 21/3697; B60Q 9/00; G07C 5/008; G06Q 30/0277; G01C 21/367

(57) ABSTRACT

Static vehicle infotainment system method to capture and transmit vehicle route data for a defined geo-fenced area. Collects and transmits vehicle data to cloud server and maps geo-fenced area using GPS coordinates to produce report and vehicle route onto infotainment screen. Collective summery report and graphical display for all vehicles within a defined GPS Geo-Fenced area can also be displayed. Additional methodology includes GPS Proximity Based Advertising and Infotainment System Advertising. GPS Proximity Based Advertising defines radius around a GPS location, displaying advertisement when vehicle enters the radius. Infotainment System Advertising receives advertisement via software or firmware, onto the infotainment system memory. Additional methodology includes receiving and displaying emergency alert emanating from integrated public alert and warning system compliant common alert protocol alert origination tool onto static infotainment system, touchscreen, audio and video control module, vehicle radio or holographic touch interface to display an image, picture, video or hologram.

### BACKGROUND

As OEM vehicle manufactures adopt in-vehicle infotainment systems, the ability to more accurately collect, receive and transmit data becomes possible. One significant advantage of the collection, receipt and transmittal of data from the original equipment manufacturer (OEM) equipment, including the infotainment system, is the ability to monitor vehicle speed, vehicle gear selection, including Park, Drive and Reverse, vehicle engine ON or OFF, vehicle GPS location and map of a defined grid using GPS latitude and longitude coordinates in decimal degrees or degrees minute seconds. Along with the increased possibilities for more accurate data, comes the ability to transmit advertisements, both with and without using GPS location, onto the infotainment system. In addition to the advertising, the increased possibility to display an image, picture, video or hologram from an Integrated Public Alert and Warning System (IPAWS) directly onto an infotainment system becomes possible.

Businesses large and small, as well as local governments, perform traffic studies on their parking lots, loading docks and roadways as vehicles enter or exit the defined GPS area. Monitoring the duration a vehicle spends in a particular parking spot, the route a vehicle takes within a defined GPS area and the speed at which the vehicle enters or leaves the defined GPS area can greatly increase the users experience, ease roadway congestion and help draw more people to any area. Reducing the number of both vehicle and pedestrian accidents is also an added benefit of the In-vehicle GPS Geo-Fencing Route Planning System.

Firmware or software specifically developed for in-dash vehicle infotainment systems has not been developed and integrated to collect vehicle traffic patterns for a defined GPS area, using OEM supplied in-vehicle modules like the body control module (BCM), powertrain control module (PCM) or transmission control module (TCM). Data to be transmitted from the vehicle over any combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network will include the time taken for a vehicle to enter or exit the defined GPS area, actual vehicle speed as the vehicle enters and remains in the defined GPS area, direction analytics for vehicle route measured by GPS latitude and longitude coordinates in decimal degrees or degrees minute seconds, duration vehicle remains in the defined GPS area, vehicle gear selection including Park, Drive and Reverse, vehicle engine ON or OFF.

Existing in-vehicle traffic monitoring systems use a vehicle's infotainment system wirelessly paired, via blue-tooth, to a peripheral device like a cellular phone. Crowd sourcing applications on the blue-tooth phone like Android Auto, use cell tower triangulation to determine vehicle speed. Other traffic monitoring systems like GPS-based Traffic Monitoring System (US20070005224 A1) require both a control module to record vehicle speed and vector positioning, as well as a transmitter to send the data that is coupled to the vehicles global positioning system (GPS). In addition to the control module and transmitter, an external traffic monitoring system is required to be placed near the roadway. Other externally mounted traffic parking modules are also required to be placed above or near each parking spot. It is only with the external mounted devises that the software is able to find the un-occupied spot and then continue to request for paying for those parking spots.

This disclosure also relates to a method utilized for In-vehicle GPS Geo-Fencing Route Planning, used to monitor traffic flow using a vehicles actual speed, as reported on the vehicle instrument control panel. OEM equipped communication networks and hardware in conjunction with the GPS Coordinate Geo-Fencing Planning Software provide a more accurate representation of speed, while not relying exclusively on continual cellular data transmissions or external transmissions.

This disclosure also relates to the data collection and transmittal method from the In-vehicle GPS Geo-Fencing Route Planning System. Data will be stored or sent via OEM equipped hardware and existing OEM equipped communication networks including over any combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network. The vehicle infotainment system will be used to in-conjunction with other vehicle modules to collect and transmit vehicle data such as vehicle speed, vehicle camera(s), vehicle object detection sensors, vehicle cardinal directions (North, South, East and West) or time duration of vehicle idling. More accurate depiction of vehicle traffic patterns for a defined GPS area are possible using the In-vehicle Traffic and In-vehicle GPS Geo-Fencing Route Planning Software. Additions such as time taken for a vehicle to enter or exit the defined GPS area, visual inspection of road surface conditions including pot-holes, visual of obstacle obstructions, speed of the vehicle within the defined GPS area, route of the vehicle in the defined GPS area and duration a vehicle once it enters the defined GPS area can now be possible.

This disclosure also relates to GPS Proximity Based Advertising. GPS Proximity Based Advertising recognizes a vehicles GPS coordinates relative to a defined GPS coordinate grid and as a result will produce virtual advertising onto a vehicle infotainment system. When a vehicle nears or enters the defined GPS coordinate grid, a localized advertisement will appear on the infotainment system. Advertisements can include any and all displays including, but not limited to pin-points on navigation maps that display local attractions including parks, restaurants, grocery stores, hospitals, schools, etc. Navigation based advertisements will include interactive one-touch directions, restaurant menus, audio, video or text displays.

This disclosure also relates to non-GPS Proximity Based Advertising or an Infotainment System Advertising method able to transmit and receive audio or video advertisements directly onto the OEM equipped hardware, while using OEM communication networks, to an infotainment system or GPS screen. Using the OEM communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network, advertisements will be sent from a cloud based server to the vehicles Satellite, GPS, Cellular, PCS or Wi-Fi antenna, where the advertisement will be processed either by a gateway module (GWM) or directly onto the infotainment system for display. While interactive infotainment system advertising methods exist (U.S. Pat. No. 8,751,293B2), these methods require feedback from the infotainment unit, such as user profile data or vehicle GPS location. Unique to our Infotainment System Advertising method is the ability to display advertised content received from the OEM equipped Satellite, GPS, Cellular, PCS or Wi-Fi antenna, translated through the gateway module (GWM), if equipped, and displayed onto the infotainment system network.

This disclosure also relates to firmware or software included on the infotainment system capable of displaying images, pictures, videos or holograms, originating from an Integrated Public Alert and Warning System (IPAWS) compliant Common Alert Protocol (CAP) Alert Origination Tool. According to the National Center for Missing and Exploited Children's 2015 Annual AMBER Alert Report, the most common reason for an AMBER Alert success story is an individual or law enforcement recognizing the vehicle from the alert at 42 percent (n=21) followed by the abductor hearing the alert and releasing the child at 20 percent (n=10). By providing a visual image, picture, video or 2D and 3D hologram of the suspect, victim, vehicle, license plate, etc., directly onto an infotainment system will increase the percentage of victims found alive and reduce the time in finding them. Both law enforcement and private citizens will cognitively recognize the vehicle, suspect or missing person from the infotainment display, which will prevent abductors from traveling greater distances and aid in a safe recovery.

Existing in-vehicle touchscreens are currently limited to displaying only emergency broadcast text messages originating from radio transmissions (U.S. Pat. No. 9,548,827). The Infotainment System picture or video emergency alert Display are activated when a Common Alert Protocol (CAP) Origination Tool transmits an image or video file sent to the vehicle touchscreen from a satellite, Wi-Fi or cell tower transmission. Firmware and or software included with the Infotainment System Picture or Video Emergency Alert Display will process the Common Alert Protocol (CAP) image, picture, video or hologram, then override the touchscreen user interface with the transmitted CAP image, picture or video transmission via an Local Interconnect Network (LIN), Local Area Network (LAN), High Speed CAN (HSCAN), Low Speed CAN (LSCAN), InfotainmentCAN (InfoCAN) or any other CAN bus network.

### SUMMARY

The following is a brief summary of subject matter that is described in greater detail herein. This summary is not intended to be limiting as to the scope of the claims.

The In-vehicle Geo-Fencing Route Planning will collect actual in-vehicle GPS coordinates, using the GPS coordinates as measured from the vehicle's Gateway Module, once the vehicle enters into a pre-defined GPS coordinate area. The movement of the vehicle, defined by the GPS coordinates within the pre-defined area, will be collected and sent at a set time interval via an OEM equipped Satellite, GPS, Cellular, PCS or Wi-Fi antenna. Individual GPS coordinate information within the pre-defined area will be transmitted to a cloud base server. The cloud based server will collect the GPS data from a multitude of individual vehicles and compress the collective data for mapping and predictive route patterns within the defined GPS area. Information from the compressed file will include an overlay of individual vehicle routes as well as hard data including time spent in the defined GPS area, time vehicle spent parked in the defined GPS area, time in Reverse in the defined GPS area and time spent in Drive or other forward moving gear and speed of the vehicle.

This disclosure also relates to the GPS Proximity Based Advertising is a method to directly display interactive web-advertisement, map of advertised locations, display phone numbers for single touch dialing, display advertised symbols, play audio recordings, play video and audio recordings, display emojis or generate a hyperlink to internet enabled content onto a stationary in-vehicle infotainment system. GPS Proximity Based Advertisements display advertised content onto the infotainment system by defining a perimeter or geo-fence using firmware or software loaded onto the gateway module (GWM), infotainment system or remote cloud servers. As the vehicle enters into the defined GPS perimeter, the advertised content will be displayed onto either the navigation map or any other user interface included with the infotainment system. The pre-defined GPS perimeter is stored onto the gateway module (GWM), infotainment system or stored on a cloud based server. Advertised content will only initiate once the vehicle GPS coordinates, as received from the OEM equipped Satellite, GPS, Cellular, PCS or Wi-Fi antenna enters into the defined GPS area.

This disclosure also relates to any other method used to directly display an interactive web-advertisement, map of advertised locations, phone number display for single touch dialing, advertised symbol display, play audio recordings, play video and audio recordings, display emojis or generate a hyperlink to internet enabled content onto a stationary in-vehicle infotainment system. Advertisements for display onto the infotainment system will be transmitted from a cloud server or mobile switching center, received via an OEM equipped Satellite, GPS, Cellular, PCS or Wi-Fi antenna then processed through OEM equipped communication network system onto the gateway module (GWM), but capable of transmitting directly onto the infotainment system.

This disclosure also relates to any method used to display an image, picture or video file onto a static in-vehicle infotainment system sent from an Integrated Public Alert and Warning System (IPAWS) compliant Common Alert Protocol (CAP) Alert Origination Tool. A unique Infotainment System Picture or Video Emergency Alert Display System that runs firmware or software, which is downloaded directly onto the memory of an infotainment system or gateway module (GWM) capable of recognizing the alert disseminator input signal transmitted from a satellite, Wi-Fi or cell tower transmission. The Infotainment System Picture or Video Emergency Alert Display executes a unique protocol to display the file extension emanating from an Integrated Public Alert and Warning System (IPAWS) compliant Common Alert Protocol (CAP) Alert Origination Tool by means of the processor housed in the infotainment system or gateway module (GWM).

### BRIEF DESCRIPTION OF THE DRAWINGS

FIG. 1 is the functional block diagram of an exemplary system that facilitates in-vehicle communication network for GPS data transmission.

FIG. 2 is a collection of data for an individual vehicle obtained from the GPS Geo-Fencing Route Planning System.

FIG. 3 is Graphical display of a GPS Geo-Fenced area and individual vehicle path.

FIG. 4 is the functional block diagram of an exemplary system that facilitates both GPS Proximity Based Advertising and Infotainment System Advertising.

FIG. 5 is a mockup of an in-vehicle infotainment system with GPS Proximity Based Advertising and Infotainment System Advertising.

FIG. 6 is a mockup of a Common Alert Protocol (CAP) picture with vital details that over-ride the user interface.

FIG. 7 is a mockup of a Common Alert Protocol (CAP) video of a live traffic camera.

FIG. 8 is a functional block diagram that illustrates the methodology above in a computing embodiment.

FIG. 9 is a flow diagram that illustrates an exemplary methodology for an Infotainment System Integrated Public Alert and Warning System (IPAWS) Visual Alert Stream Process Flow.

FIG. 10 is a functional block diagram that facilitates an exemplary system to display an Integrated Public Alert and Warning System (IPAWS) Visual Alert onto the user interface of a static in-vehicle infotainment system, touchscreen, audio and video control module, vehicle radio or holographic touch interface.

### DETAILED DESCRIPTION

Pertaining to systems for Geo-Fencing Route Planning, Infotainment System Advertising and Infotainment System Picture or Video Emergency Alert Display onto an OEM equipped integrated in-vehicle infotainment system are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

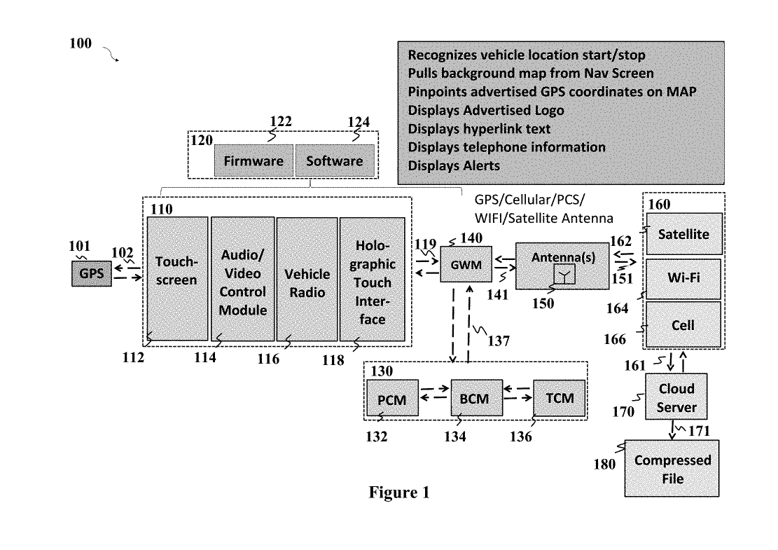

With reference to FIG. 1, an exemplary system 100 that facilitates graphical display of a GPS Geo-Fencing Route Plan onto the GPS navigation interface 101 of an infotainment system, used to display vehicle positioning is illustrated. GPS navigation interface 101 receives input signal 102 from the infotainment system network 110 includes a touchscreen 112, audio and video control module 114, vehicle radio 116 and holographic touch interface 118. The touchscreen interface 112 and audio/video control module 114 has two functions: an in-dash touchscreen input to select from one of the input signals, and an audio and video control function. In one embodiment, an audio and video control module 114 is a separate function from the touchscreen 112: in other words, the infotainment system interface 112 represents an in-dash touchscreen input only. In another embodiment, the vehicle radio 116 is used in conjunction with a touchscreen 112. In yet another embodiment, the vehicle radio 116 is used in conjunction with an audio and video control module 114. In yet another embodiment, the holographic touch interface is used in conjunction with any combination including the infotainment system 112, audio and video control module 114 or vehicle radio 116. In yet another embodiment, the holographic touch interface is a stand-alone system within network 110.

The network 120 includes a firmware 122 and software 124 for download onto one or more of the embodiments in the infotainment system network 110. Function of network 120 will include a method to recognize and store the defined Geo-fencing area from the GPS latitude and longitude coordinates in decimal degrees or degrees minute seconds.

The network 130, independent of infotainment network 110, includes a Powertrain Module (PTM) 132, Body Control Module (BCM) 134 and Transmission Control Module (TCM). Function of network 130 will recognize when vehicle engine is On or Off, speed of vehicle and transmission gear (Park, Drive, Neutral, First, Second, etc.). In one embodiment, the Powertrain Control Module (PCM) 132 communicates directly to any of the embodiments as seen in Network 110. In another embodiment, the Body Control Module 134 communicates directly to any of the embodiments as seen in network 110 via input signal 137. In yet another embodiment the Transmission Control Module (TCM) communicates directly to any of the embodiments as seen in network 110 via 137. In yet another embodiment the Powertrain Control Module (PCM) 132 communicates to the Body Control Module (BCM) 134 and both or one of the modules communicates back to any of the embodiments as seen in network 110 via 137. In yet another embodiment the Transmission Control Module (TCM) 136 communicates to the Body Control Module (BCM) 134. In yet another embodiment, both the Powertrain Control Module (PCM), Body Control Module (BCM) and Transmission Control Module (PCM) communicate directly to each other. In yet another embodiment the Powertrain Control Module (PCM) and Transmission Control Module (TCM) communicate directly to each other.

Input signal 119 received from infotainment system network 110 is processed from the Gateway Module (GWM) 140, if equipped. If not equipped, the Gateway Module (GWM) 140 is bypassed.

Antenna 150 includes any embodiment of a singular or plurality of in-vehicle antenna(s) including GPS, Cellular, PCS, WIFI or Satellite. Antenna 150 transmits and receives data for any and all embodiments included from networks 100, 120, 130 and 140 via input signal 141 if equipped with a Gateway Module 140, if not equipped with Gateway Module 140 input signal 119.

The network 160 includes an exemplary system that facilitates a method to transmit or receive data into the vehicles antenna(s) 150 via input signal 151. The network 160 includes an array of transmitters including a Satellite 162, Wi-Fi 164 and Cell Tower 166. In one embodiment the data from network 160 will be transmitted or received from a Satellite transmitter 162 directly onto the vehicle antenna 150 via input signal 151. In another embodiment the data from network 160 will be transmitted or received from external Wi-Fi transmitter 164 directly onto the vehicle antenna 150 via input signal 151. In yet another embodiment the data from network 160 will be transmitted or received from Cell Tower 166 directly to a vehicle antenna 150 via input signal 151. In yet another embodiment the data from network 160 will be transmitted or received in conjunction with a plurality of transmitters or receivers including Satellite Antenna 162, external Wi-Fi Antenna 164 and Cell Tower 166 directly to the vehicle antenna 150 via input signal 151.

Cloud server 170 is an external remote device responsible for transmitting to and receiving data from network 160 via input signal 161. Cloud server 170 collects data and in one embodiment compresses that data, included from networks 100, 110, 120, 130, 140, 150 and 160. Data to be available on the server is, but not limited to, all information relating to capturing vehicle data.

Compressed data file 180 is a summary of information collected from data available on Networks 100, 110, 120, 130, 140, 150, 160 and 170 via output signal 171. Compressed data file 180 can be configured to query out any and all data available obtained from networks 100,110,120, 130, 140, 150, 160 and 170. Geo-Fencing Route Planning GPS perimeters are uploaded onto the Server 170 and can be changed over-the-air with vehicle software or firmware re-flashing. When changes occur to GPS perimeters, i.e. perimeters deleted, added or modified, the subsequent changes to the Compressed File 180 will be changed accordingly.

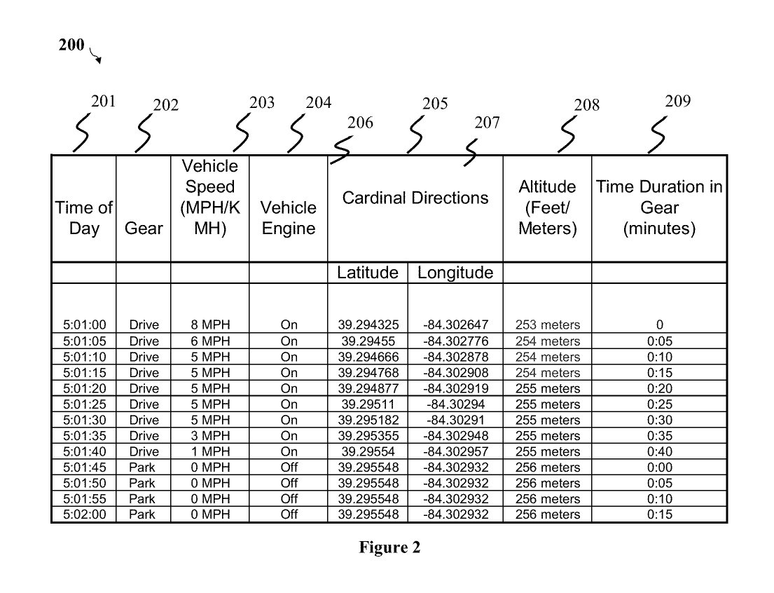

Referring now to FIG. 2, a summary of individual vehicle data 180 as received from Cloud Server 170. Data exported from the server for this embodiment is Time of Day 201 as recognized on network 160, vehicle Gear 202 as recognized by network 130, vehicle Speed 203 as recognized by network 130, vehicle Engine (On/Off) 204 as recognized by network 130, Cardinal Directions 205 collected in including Latitude 206 in decimal degrees or degrees minute seconds and Longitude in decimal degrees or degrees minute seconds 207 as interpreted by network 110 as received by the vehicle Antenna 150. Altitude 208, measured in feet or meters, as recognized by network 130 as received by the vehicle antenna 150. Time Duration in Gear 209 records the time duration a vehicle is in a set gear (Park, Drive, Neutral, First, Second, Third, etc.) as interpreted from network 130.

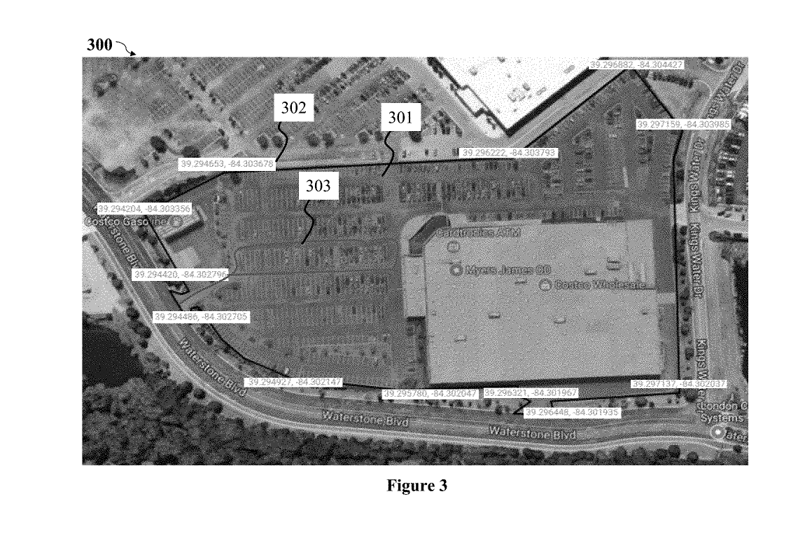

Referring now to FIG. 3, a graphical display defining a geo-fenced area 300 is detailed. Area highlighted demonstrates a visual boundary of a geo-fenced area 301 where data is to be collected for the Geo-Fencing Route Planning System. Geo-fenced area 301 is defined by latitude decimal degrees or degrees minute seconds and longitude in decimal degrees or degrees minute seconds 302. Geo-fenced area is modified and updated by modifying network 120 by a firmware 122 and software 124 update, which is uploaded onto the Cloud Server 170, sent to network 160 including any embodiment of transmission sequence Satellite 162, Wi-Fi 164 or Cell Tower 166 and interpreted by any embodiment in network 110 or gateway module 140. Vehicle route path 303 graphically displays a visual displays that outlines the path of individual vehicle on route through the defined geo-fenced area.

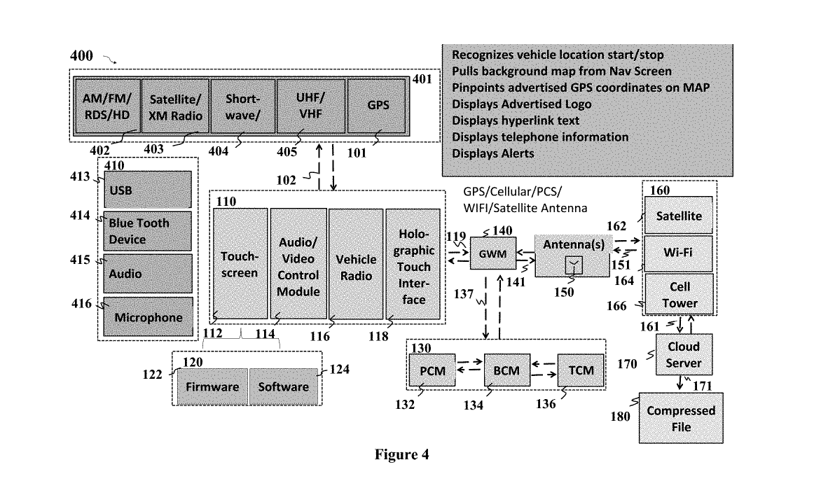

Referring now to FIG. 4, an exemplary system 400 that facilitates the transmission of both GPS Proximity Based and non-GPS Proximity Based Infotainment System Advertisements onto the user interface of Network 401 via input signal 102. The input signal, in exemplary example is the user interface for an Over-The-Air (OTA) broadcast signal AM, FM, HD or Radio Data System (RDS) 402 that is regularly broadcast over airways transmitted via a licensed station's transmitter. Other exemplary examples of the input signal Satellite or XM radio 403, a Short Wave or Digital Radio Mondiale (DRM) 404, UHF or VHF Radio and Television 405 and GPS navigation map 101. Network 410 inputs a signal 411 to the infotainment system from a USB bus 413, a Bluetooth device 414, an audio input jack 415, or a microphone 416. Infotainment network 110 including, but not limited to touchscreen 112, audio and video control module 114, vehicle radio 116 or holographic touch interface 118 will transmit an advertisement onto the user interface of any of the embodiments included in network 401. In one embodiment the gateway module (GWM) 140 receives an input signal 119 and processes the protocol included in network 120 including firmware 122 or software 124. In another embodiment the infotainment system 110 including, but not limited to touchscreen 112, audio and video control module 114, vehicle radio 116 or holographic touch interface 118 executes the process included in network 120 including firmware 122 or software 124. Input signal 141 is received in-vehicle from a GPS/Cellular/PCS/WiFi/Satellite Antenna 150 and supplied by input signal 151 sent from a network of data transmitters 160 including, but not limited to a Satellite 162, WiFi 164 or Cell Tower 166. Cloud Server 170, which defines the advertisement to be transmitted, sends an input signal 161 onto network 160 for routing of advertisement onto the user interface of one of the embodiments in infotainment system network 401.

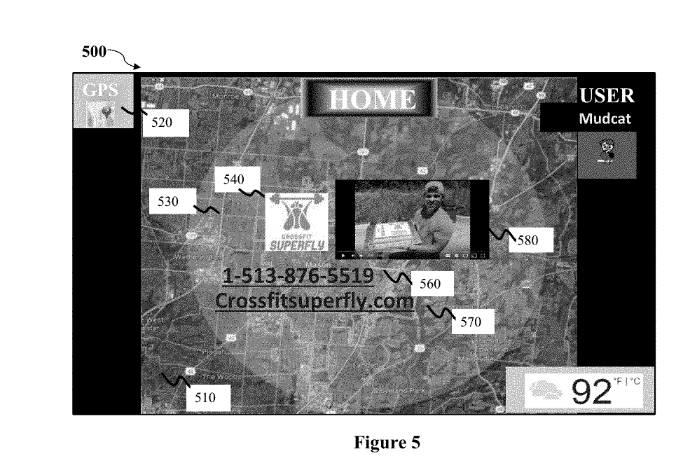

Referring now to FIG. 5, a mockup of an infotainment system for a GPS display 500 is illustrated. The GPS display 510 is comprised of a GPS icon 520 in the upper most left hand portion of the display and a GPS navigation map. In one embodiment to display GPS Proximity Based Advertisements, a non-visible radius 530, with center positioned on the address location of advertised location is to be recognized based on vehicle position as detailed in the GPS location as received from the antenna 140. In this embodiment advertisements including an icon or logo 540, a hyperlink phone number 560 that when paired to the user's phone, via Bluetooth connection 414, user will dial the advertised number with one-touch of the Touchscreen 560. Also in this embodiment is an advertised hyperlink to web-page 570, that if vehicle is connected to internet via network 160, the link will pull-up the advertised content when user selects the hyperlink 570 from the touchscreen. In yet another embodiment of this display, Video advertisements 580 will be appear on the infotainment system. Video advertisements will be stored locally on the memory of any embodiment of network 110 or streamed live to the Antenna 150.

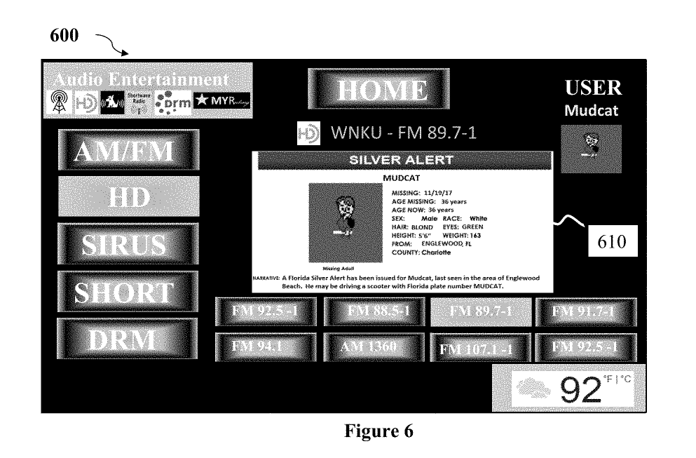

Referring now to FIG. 6, a mockup of an infotainment system user interface 600 is illustrated. In one embodiment a Common Alert Protocol (CAP) visual alert in the form of a picture with a released Silver Alert bulletin 610 is displayed. Descriptive details in the bulletin can include, but not limited to, missing date, age missing, age now, sex, race, hair, eyes, height, weight, city from, county, narrative details or any other pertinent information included in the alert.

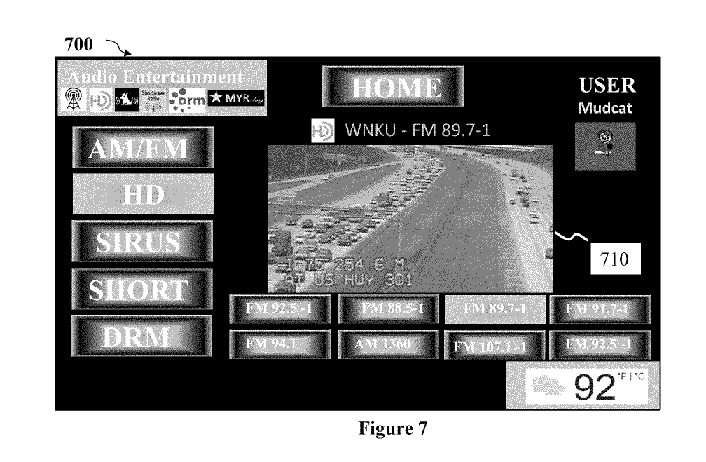

Referring now to FIG. 7, a mockup of an infotainment system user interface 700 is illustrated. In one embodiment a Common Alert Protocol (CAP) visual alert in the form of a video with a live traffic feed. Evacuation routes and natural disaster areas can be broadcast to safely warn occupants of impending danger.

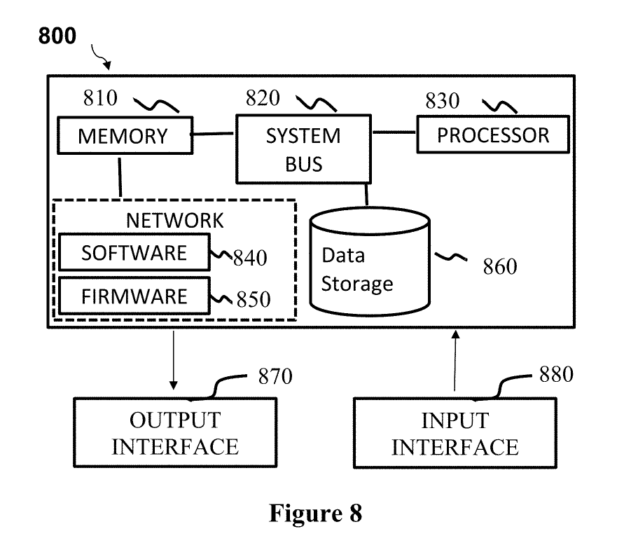

Referring now to FIG. 8, an illustration of an exemplary computing device 800 that can be used in accordance with the systems and methodologies disclosed herein is illustrated. The computing device 800 includes memory 810 which executes stored instructions for implanting functionality described as being carried out by one or more components discussed above. Data received from the system bus 820 is processed by at least one processor 830 that executes instructions that are stored in memory 810. Instructions for implementing functionality described as being carried out by one or more components discussed above or instructions for one or more of the methods described above that are carried out by either the software 840 or firmware 850. The computing device 800 additionally includes a data storage 860 that is accessible by the processor 830 through the system bus 820. The data storage 860 may include executable instructions. The computing device 800 also includes an input interface 880 that allows external devices to communicate with the computing device 800. For instance, the input interface 880 may be used to receive instructions from an external computer device, from a user, etc. The computing device 800 also includes an output interface 870 that interfaces the computing device 800 with one or more external devices. For example, the computing device 800 may display video or images, etc. by way of the output interface 870.

It is contemplated that the external devices that communicate with the computing device 800 via the input interface 880 and the output interface 870 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent Infotainment System Network 401 to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

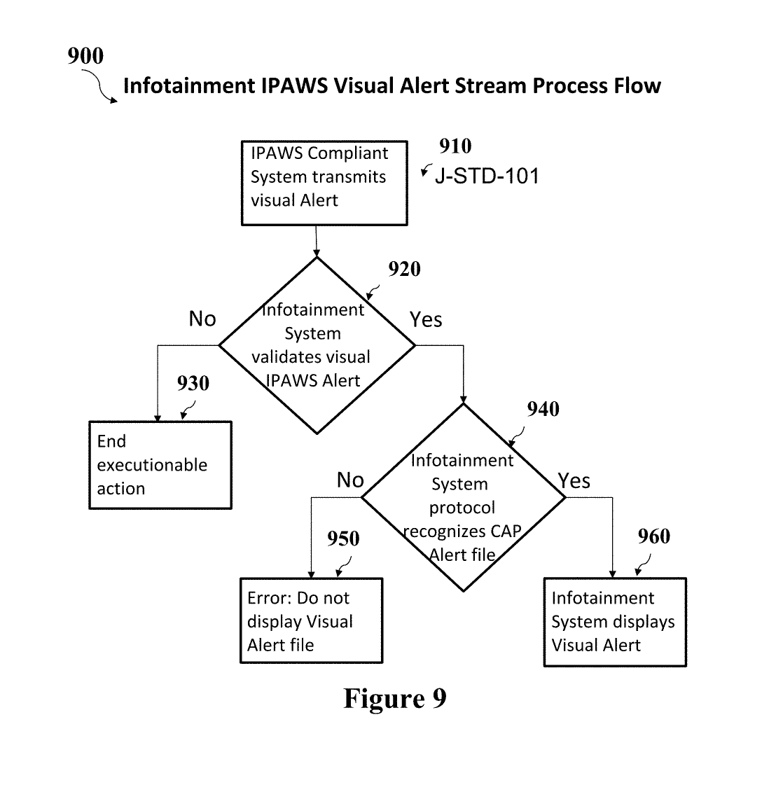

Referring now to FIG. 9, a methodology 900 that facilitates the transmission of a video or picture emanating from an Integrated Public Alert and Warning System (IPAWS) compliant Common Alert Protocol (CAP) Origination Tool, directly onto the user interface of an infotainment system. The methodology 900 begins at 910, where an IPAWS Compliant System transmits a visual alert in the form of a video, image or picture. The methodology then transitions to infotainment system validating the receipt of the visual IPAWS alert 920. If the infotainment system is not able to validate the alert was received, this will signal an end to the exceptionable action 930 and no alert will be shown. If the infotainment system validates that an IPAWS alert was received by the infotainment system, the methodology transitions to a protocol recognizing the Common Alert Protocol (CAP) alert file extension 940. If the Common Alert Protocol (CAP) file extension is not recognized, the methodology transitions to an internal error where no visual alert 950 or image, picture or video will appear onto the user interface of the infotainment system, touchscreen, audio control module or vehicle radio. If the Common Alert Protocol (CAP) file extension is recognized, the methodology transitions to displaying the visual alert 960 directly onto the user interface of the infotainment system, touchscreen, audio and video control module, vehicle radio or holographic touch interface.

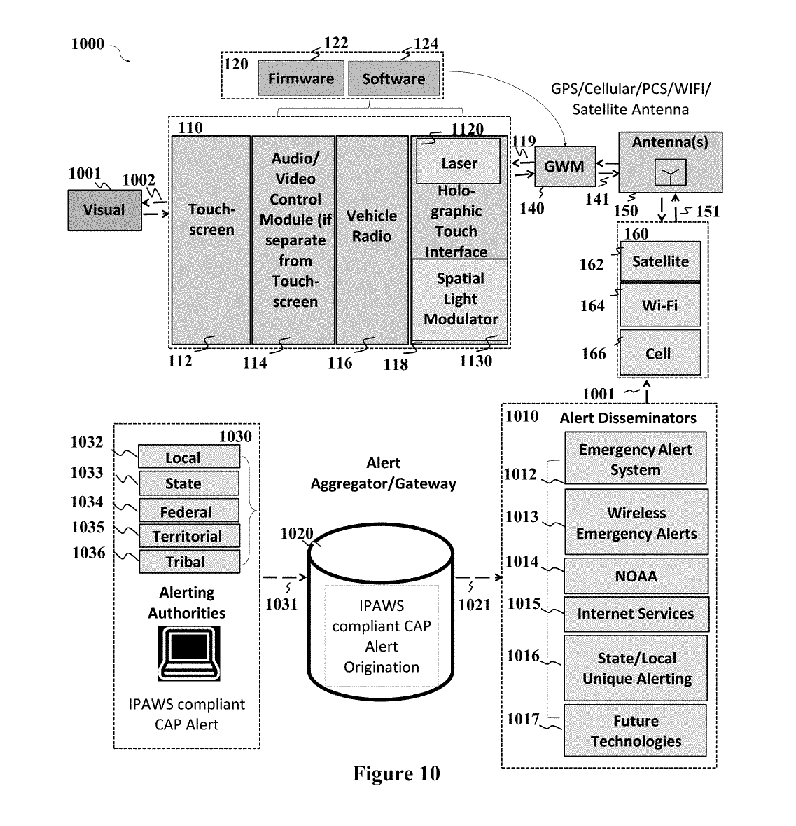

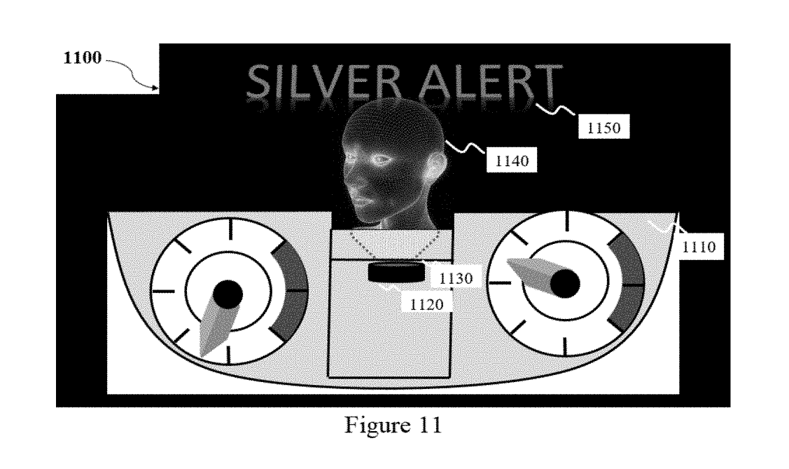

FIG. 10 is a functional block diagram of an exemplary system 1000 that facilitates the transmission of an Integrated Public Alert and Warning System (IPAWS) visual alert 1001 by means of an input signal 1002 in the form of an image, picture or video onto an Infotainment System 110 including, but not limited to Touchscreen 112, Audio and Video Control Module 114, Vehicle Radio 116 or Holographic Touch Interface 118 or any other method to display an image, picture or video sent from IPAWS visual alert. In one embodiment the Gateway Module (GWM) 140 sends an input signal 119 to network 110 and processes the protocol included in network 120 including Firmware 122 or Software 124. In another embodiment the infotainment system network 110 processes the protocol included in network 120 including Firmware 122 or Software 124 via input signal 141, if system is not equipped with Gateway Module (GWM). Input signal 151 is received in-vehicle from a GPS/Cellular/PCS/WiFi/Satellite Antenna 150 and supplied by a network of data transmitters 160 including, but not limited to a Satellite 152, WiFi 154 or Cell Tower 156. Input signal 1001 received by Network 160 is transmitted by a Common Alert Protocol Alert Disseminator 1010 including an Emergency Alert System 1012, Wireless Emergency Alerts (WEA) System 1013, NOAA 1014, Internet Services 1015, State/Local Unique Alerting Systems 1016 or Future Technologies 1017. Input signal 1021 received by an Alert Disseminator 1010 is fed the image, picture or video file extension by means of an Alert Aggregator/Gateway 1020, IPAWS Open, Message Router (Open Platform for Emergency Networks). Input signal 1031 received by the Alert Aggregator/Gateway 1020 is sent the image, picture or video file extension by means of an Alerting Authority Network 1030 including Local Authority 1032, State Authority 1033, Federal Authority 1034, Territorial Authority 1035 or Tribal Authority 1036 by means of a IPAWS compliant CAP origination tool.

Referring now to FIG. 11, a mockup of a holographic touch interface 1100 is illustrated. In one embodiment a Common Alert Protocol (CAP) visual alert in the form of a 3D hologram is displayed from a holographic touch interface. Image of an in-vehicle gauge cluster 1110 is displayed with a laser 1120 and spatial light modulator (SLM) 1130 used to display a holographic image. Spatial light modulator 1130 will display a 2D or 3D graphical image 1140 as received by input signal 119 sent from a Common Alert Protocol (CAP). Along with the 2D or 3D image 1140, holographic text 1150 in conjunction or independent of the image can be displayed in hologram formpe.

While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Plurality of in-vehicle communication networks pre-existing in vehicle including CAN bus networks designed with multiplex electrical wiring, allowing in-vehicle microcontrollers and modules to communicate between each other exist in a multitude of embodiments. Local Interconnect Network (LIN) operating on 1 Kbps to 20 Kbps. High Speed CAN (HSCAN) operating between 125 Kpbs and 500 Kbps. Low Speed CAN (MSCAN) operating between 40 Kbps and 125 Kbps. InfotainmentCAN (InfoCAN) and Local Area Network (LAN) operating from a transfer speed of both 40 Kbps to 125 Kbps or 125 Kbps to 500 Kbps, when paired to other in-vehicle microcontrollers or transfer speeds ranging from 1 Kbps to 11 Gbps on a cellular network or 11 Mbps to 7,000 Mbps operating on Wi-Fi, with speeds falling under Wi-Fi standards 802.11b, 802.11a, 802.11g, 802.11n or 802.11ac.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

Image or picture file formats can include raster graphics in a dot matrix data structure, raw image file, 2D vector graphics, 3D vector graphics, compound and stereo format. Raster graphics can include any file extensions, including but not limited to ANI, ANIM, APNG, ART, BMP, BPG, BSAVE, CAL, CIN, CPC, CPT, DDS, DPX, ECW, EXR, FITS, FLIC, FLIF, FPX, GIF, HDRi, HEVC, ICER, ICNS, ICO/CUR, ICS, ILBM, JBIG, JBIG2, JNG, JPEG, JPEG 2000, JPEG-LS, JPEG XR, KRA, MNG, MIFF, NRRD, ORA, PAM, PBM/PGM/PPM/PNM, PCX, PGF, PlCtor, PNG, PSD/PSB, PSP, QTVR, RAS, RBE, JPEG-HDR, Logluv TIFF, SGI, TGA, TIFF, TIFF/EP, TIFF/IT, UFO/UFP, WBMP, WebP, XBM, XCF, XPM and WD. Raw image file formats can include, but not limited to CIFF or DNG file formats. 2D vector graphics can include file formats, but not limited to AI, CDR, CGM, DXF, EVA, EMF, Gerber, HVIF, IGES, PGML, SVG, VML, WMF, Xar. 2D Coumpund formats can include CDF, DjVu,EPS, PDF, PICT, PS, SWF and XAML. 3D Vector graphics include AMF, Asymptote, .blend, COLLADA, .dgn, .dwf, .dwg, .dxf, eDrawings, .flt, HSF, IGES, IMML, IPA, JT, .MA, .MB, .OBJ, OpenGEX, PRC, STEP, SKP, STL, U3D, VRML, XAML, XGL, XVL, xVRML, X3D, .3D, 3DF, .3DM, .3ds, 3DXML and X3D. 3D compounded formats include, but not limited to EPS, PDF, PostScript, PICT, SWF and XAML.

Video file formats include, but not limited to file extensions, .webm, .mkv, .flv, .flv, .vob, .ogv, .ogg, .drc, .gif, .gifv, .mng, .avi, .mov, .qt, .wmv, .yuv, .rm, .rmvb, .asf, .amv, .mp4, .m4p (with DRM), .m4v, .mpg, .mp2, .mpeg, .mpe, .mpv, .mpg, .mpeg, .m2v, .m4v, .svi, .3gp, .3g2, .mxf .roq, .nsv, .flv, .f4v, .f4p, .f4a, and .f4b.

What is claimed is:

1. An infotainment system, comprising:
a plurality of input signals transmitted over any combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network.
an audio and video control module coupled to the plurality of input signals, the audio and video control module configured to receive user input;
a touchscreen module, the touchscreen module configured to respond to the user input, the user input selecting from one of the plurality of input signals;
a vehicle radio, the touchscreen module configured to respond to the user input, the user input selecting from one of the plurality of input signals;
a 2D or 3D holographic touch interface configured to respond to the user input, the user input selecting from one of the plurality of input signals;
a gateway module, the gateway module coupled to the audio and video control module, touchscreen module or vehicle radio, the gateway module configured to receive a user data; and
an antenna module, the antenna module coupled to the gateway module, vehicle radio, audio and video module, touchscreen or holographic touch interface to the antenna module configured to transmit the user data to a cellular tower.

2. The system of claim 1, further comprising software or firmware capable of defining a GPS geo-Fenced area using GPS latitude and longitude coordinates in decimal degrees or degrees minute seconds;

3. The system of claim 1, further comprising a body control module, powertrain control module, transmission module or any OEM supplied module, independent of infotainment system network 110 capable of collecting and transmitting individual vehicle data coupled with GPS route data including, but not limited to Time of Day, Gear, Vehicle Speed, Vehicle Engine, Cardinal Directions including Latitude and Longitude, Altitude and Time Duration in Gear;

4. The system of claim 1, further comprising a GPS navigation screen to display a visual overlay map of the defined geo-fenced area outlined by GPS Latitude and Longitude coordinates in Decimal Degrees or Degrees Minute Seconds.

5. The system of claim 1, displaying visual depiction of a vehicle route path of an actual route traveled by an individual vehicle onto a navigation user interface as defined by GPS Latitude and Longitude coordinates in Decimal Degrees or Degrees Minute Seconds.

6. A method of displaying and transmitting an interactive advertisement not associated to user defined data, vehicle sensors or retained behaviors inferred from the vehicle event data for collection display onto an in-vehicle infotainment system, touchscreen, audio and video control module, video radio or holographic touch interface comprising;
transmitting the advertisement content from a Cloud Server to a Satellite, Wi-Fi or Cell Tower; responsive to transmitting the advertisement content from a Cloud Server to a transmitter including, but not limited to a Satellite, Wi-Fi or Cell Tower, transmitting the advertisement from a Satellite, Wi-Fi or Cell Tower to a vehicle's antenna;
responsive to transmitting the vehicle's antenna,
transmitting the advertisement to an internet and to the touchscreen, audio and video control module, vehicle radio, holographic touch interface or gateway module over any singular or combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network.

7. A system to display a GPS proximity based advertisement onto an in-vehicle infotainment system comprising:
a processing unit;
a memory;
instructions in the memory, that, when executed by the processing unit, perform the following acts:
recognize vehicle location as defined by GPS latitude and longitude coordinates in decimal degrees or degrees minute seconds;
recognize GPS geo-fenced perimeter as defined by GPS latitude and longitude coordinates in decimal degrees or degrees minute seconds for advertiser;
recognize vehicle location within GPS geo-fenced area as defined by GPS latitude and longitude coordinates in decimal degrees or degrees minute seconds;
responsive to displaying advertisement, execute protocol recognizing type of advertisement, then displaying advertisement to touchscreen, audio and video module, vehicle radio, holographic touch interface, gateway module over any singular or combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network.

8. A method of claim 7, wherein instructions in the memory, that when executed by the processing unit;
read and decipher input signal advertisement;
responsive to read and decipher input signal advertisement, processing input signal into advertisement display consisting of an icon or logo, hyperlink phone number, hyperlink webpage, alert or audio and video advertisement onto touchscreen, audio and video module, vehicle radio, holographic touch interface or gateway module over any singular or combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network.

9. A method of displaying an Image or Video Alert transmitted from an Integrated Public Alert and Warning System (IPAWS) via a compliant Common Alert Protocol (CAP) Alert Origination Tool onto a vehicle infotainment system, touchscreen, audio and video control module, vehicle radio or holographic touch interface.

10. An infotainment system comprising:
a processing unit;
a memory;
instructions in the memory, that, when executed by the processing unit, perform the following acts:
recognize an Integrated Public Alert and Warning System (IPAWS) sent from a Common Alert Protocol (CAP) Alert Origination Tool compliant emergency broadcast signal has been received;
validate file extension for an Integrated Public Alert and Warning System sent from a Common Alert Protocol (CAP) Alert Origination Tool;
run protocol to display an image, picture or video alert onto the user interface of an infotainment system, touchscreen, audio or video control module, vehicle radio or holographic touch interface;
responsive to read and decipher an Integrated Public Alert and Warning System (IPAWS) sent from a Common Alert Protocol (CAP) Alert Origination Tool, processing that input signal into recognizing the file extension, then displaying the image or video file directly onto the user interface of the touchscreen, audio and video control module, vehicle radio or holographic touch interface over any singular or combination of communication networks including, but not limited to Local Interconnect Network (LIN), Local Area Network (LAN), High Speed CAN (HSCAN), Low Speed CAN (LSCAN), InfotainmentCAN (InfoCAN) or any other CAN bus network.

11. A method of claim 10, wherein instructions in the memory, that when executed by the processing unit;
read and decipher an image, picture or video input signal from an Integrated Public Alert and Warning System (IPAWS) sent from a Common Alert Protocol (CAP) Alert Origination Tool;
responsive to read and decipher an image, picture or video input signal from an Integrated Public Alert and Warning System (IPAWS) sent from a Common Alert Protocol (CAP) Alert Origination Tool, execute protocol recognizing type of extension file, then display an image, picture or video to an in-vehicle infotainment system, touchscreen, audio and video control module, vehicle radio or holographic touch interface;
responsive to successful processing of infotainment recognizing type of extension file, then displaying image, picture, video or hologram onto an in-vehicle infotainment system, touchscreen, audio and video control module, vehicle radio or holographic touch interface that will override current image, picture, video or hologram display.
